(19) United States
(12) Patent Application Publication
(10) Pub. No.: US 2018/0056830 A1
(43) Pub. Date: Mar. 1, 2018

(54) SINGLE SPRING LINEAR ADJUSTING LOCK

(71) Applicants: JAMES CRIPE, CUTLER, IN (US); BRIAN STOWELL, INDIANAPOLIS, IN (US)

(72) Inventors: JAMES CRIPE, CUTLER, IN (US); BRIAN STOWELL, INDIANAPOLIS, IN (US)

(73) Assignee: PANGEO GROUP LLC, Novi, MI (US)

(21) Appl. No.: 15/247,969

(22) Filed: Aug. 26, 2016

(51) Int. Cl. B60N 2/46; F16C 11/10; A47C 7/54

(52) U.S. Cl. CPC B60N 2/4633; F16C 11/10; A47C 7/54; A47C 7/543; B60N 2/4606

(57) ABSTRACT

The present invention is an improved mechanical linear locking device, with a single locking coiled spring. When firmly coiled, the single locking coil spring is able to grip a smooth rod and prevent axial motion. When the single locking coil spring is uncoiled, slightly, it releases its grip on the smooth rod, allowing axial motion. The single spring linear adjusting lock device is used in an armrest with memory. The present invention uses a rod, a return spring, an annular bearing, a sleeve, a two-piece housing, a coil spring, a bushing, and a cylinder with protruding trunnions.

### FIELD OF INVENTION

This invention relates to the classification of chairs and seats, and to one or more sub-classifications under armrests. Specifically, this invention is an armrest lock with memory.

### BACKGROUND OF INVENTION

Automobiles have had seats since the very beginning. The first automobiles used bench seats. After WWII, European automakers introduced bucket seats, seats contoured to hold one person, in an effort to conserve space and cost. In the 1980s, automakers introduced minivans, which used a raised, standalone variation of the bucket seat, often called a captain's seat. Captain's seats have become ubiquitous in both minivans and SUVs.

In most sedans, the front seat is afforded with one armrest on the door panel and center console, each. Due to their elevation, automotive captain's seats often have integral armrests built into the frame of the seat-back.

An armrest mounted on the seatback introduces a number of new design issues and challenges. While many armrests accommodate basic seat occupant needs, such as providing an occupant with a place to rest his or her arms, many armrests do not provide advantageous options with respect to armrest positioning and stowing. Currently, most armrests attaching to the seatback are usually anchored with bolts, pins, or other fasteners devices. These are installed through the armrest into the seatback frame. Currently, most armrests are capable of rotating from a stowed position to a use position, and back. Some armrests allow the user to adjust the use position. While this current state of the art is functional, it is inefficient for users, because it usually does not allow a user to retrieve an armrest from a stowed position and return it to the previous use position.

Recently, advances in the art disclose mechanical armrests with the ability to be retrieved from an upward stowed position and be placed in previously “memorized” position simply by rotating the armrest. Additionally, the current state of the art also teaches mechanical armrests with the ability to be retrieved from a downward stowed position and placed in a previously “memorized” position simply by rotating the armrest. The problem with the current state of the art is that mechanical armrests with memory functionality tend to be complex. The complexity can lead to issues of weight, cost, and reliability. The art is still seeking an easy to install memory armrest for the use in captain's seats that is lightweight, simple, cost effective, reliable, and easy-to-use.

### PRIOR ART REVIEW

There is clearly a market demand for a simple, lightweight, inexpensive, reliable and easy-to-use memory armrest. The recent prior art shows many examples that attempt to provide such a solution, all of which fail in some aspect. For example, U.S. Utility Pat. No. 8,132,861, by named inventor Cone, entitled, “Adjustable sliding armrest” (“Cone '861”); and U.S. Utility Pat. No. 8,333,432, by named inventor Cone, entitled, “Adjustable sliding armrest” (“Cone '432”) both teach an adjustable sliding armrest that may be extendable in length and varied in rotational position. U.S. Utility Pat. No. 9,321,381, by named inventor Itzinger, entitled, “Armrest device for a vehicle seat” (“Itzinger '381”) teaches a pivoting and locking armrest with a compact and secure pivot bearing. Itzinger '381, Cone '861, and Cone '432 all fail to provide a memory function in their disclosure.

U.S. Utility Pat. No. 6,467,847, by named inventor Bidare, entitled, “Comfort armrest with memory” (“Bidare '847”) teaches an armrest with memory, and a “down” storage position. Bidare '847 is very complex with a peripheral raised portion that likely does not wear well in harsh automotive environments.

U.S. Utility Pat. No. 7,845,732, by named inventors Liu, et. al., entitled, “Vehicle armrest positioning assembly” (“Liu '732”) teaches an armrest with memory using a helical lock spring. The helical lock spring has some characteristics in common with the present invention, however, Liu '732 uses two helical locking springs, rather than one, and is more complex, than the present invention.

### SUMMARY OF THE INVENTION

This summary is intended to disclose the present invention, a single spring linear adjusting lock, with memory, for use in an automotive armrest. The embodiments and descriptions are used to illustrate the invention and its utility, and are not intended to limit the invention or its use.

The present invention relates to using an improved mechanical linear locking device, with a single locking coiled spring. When firmly coiled, the single locking coil spring is able to grip a smooth rod and prevent axial motion. When the single locking coil spring is uncoiled, slightly, it releases its grip on the smooth rod, allowing axial motion. The single spring linear adjusting lock device is used in an armrest with memory.

The present invention comprises a rod, a return spring, an annular bearing, a sleeve, a two-piece housing, a coil spring, a bushing, and a cylinder with protruding trunnions. Collectively, the annular bearing, sleeve, two-piece housing, coil spring, bushing, and cylinder with protruding trunnions are called the Axial Lock. The rod has a rod hole at one end and smooth, cylindrical opposing end over which the annular bearing, sleeve, two-piece housing, coil spring, bushing, and cylinder with protruding trunnion fit. The rod hole is connected to a control member. The cylinder's protruding trunnions mate with a mating hole in a positioning system bracket and a mating hole in the support arm.

The coil spring is made of spring steel, or similar spring material, and has two protruding ends. The two protruding ends are axially disposed at approximately a 90° angle from one another. When the single spring linear adjusting lock is used in a memory armrest, the coil spring has one protruding end fixed against rotation in a notch in the sleeve and the other protruding end fixed against rotation in the bushing. The sleeve is a cylinder with a flat blade extending orthogonally from its outer surface. The interior of the sleeve facing the coil spring has a ramp feature. The ramp feature is achieved by beveling the inner surface of the sleeve towards the cylinder end. The bushing also has a ramp feature. The sleeve has a notch that mates with a protruding end of the coil spring.

When a compressive load is applied to the armrest, the ramp feature inside the bushing causes the coil spring coils to tilt and grip the rod in proportion to the load. When a tensile load is applied to the armrest, a ramp feature inside the sleeve causes the coil spring coils to tilt in the opposite orientation and grip the rod in proportion to the load. The single spring linear adjusting lock device is unlocked by applying pressure to the sleeve blade, until the sleeve blade rotates through an acute angle. The coil spring is unwound, slightly, which causes the inside diameter of the coil spring to increase until there is a clearance between the coil spring and the rod. In this condition, the Axial Lock is free to move axially on the rod to provide a re-positioning function. This allows the relative distance between the control member and the positioning system bracket to be adjusted by sliding the Axial Lock along the rod. The Axial Lock is re-locked to the rod, in any position, by removing the pressure on the sleeve blade. When the blade is released, the armrest will remember the new position, because the relative distance between the control member and the positioning system bracket will be locked. This sets the new use position for the armrest.

### BRIEF DESCRIPTION OF THE DRAWINGS

The present invention is illustrated with 6 drawings on 7 sheets. FIG. 1A is an exploded isometric view of a double spring linear adjusting lock mechanism, in situ, with the interior components of a memory armrest. FIG. 1B is an exploded isometric view of the present invention, a single spring linear adjusting lock mechanism, in situ, with interior components of a memory armrest.

FIG. 2A is an isometric drawing of a right-handed piece of a two-piece housing for a double spring linear adjusting lock mechanism. FIG. 2B is an isometric drawing of a right-handed piece of a two-piece housing for a single spring linear adjusting lock mechanism.

FIG. 3A is an isometric view of a return spring for a double spring linear adjusting lock mechanism. FIG. 3B is an isometric view of a return spring for a single spring linear adjusting lock mechanism.

FIG. 4A is an isometric view of a bushing used in a double spring linear adjusting lock mechanism. FIG. 4B is an isometric view of an annular bearing used in a single spring linear adjusting lock mechanism.

FIG. 5A is an isometric view of the two coil springs used in a double spring linear adjusting lock mechanism. FIG. 5B is an isometric view of the coil spring used in a single spring linear adjusting lock mechanism.

FIG. 6A is an isometric view of a sleeve used in a double spring linear adjusting lock. FIG. 6B is an isometric view of a sleeve used in a single spring linear adjusting lock

### DETAILED DESCRIPTION OF THE DRAWINGS

The following descriptions are not meant to limit the invention, but rather to add to the summary of invention, and illustrate the present invention, by offering and illustrating various embodiments of the present invention, a single spring linear adjusting lock device. While embodiments of the invention are illustrated and described, the embodiments herein do not represent all possible forms of the invention. Rather, the descriptions, illustrations, and embodiments are intended to teach and inform without limiting the scope of the invention.

The easiest way to illustrate the present invention is to compare it to the current state of the art, a double spring linear adjusting lock, similar to that used Liu 732.

FIG. 1A shows a double spring linear adjusting lock, in situ, with a memory armrest. The double spring linear adjusting lock is comprised of a rod 24, a return spring 17, a two-piece housing 16A, 16B, a notched bushing 18, a helical coil spring 20, a sleeve with blade 21, a second helical coil spring 19, an unnotched bushing 23, and a cylinder with protruding trunnions 22. The double spring linear adjusting lock interacts with an armrest 1 mechanism in order to provide a memory feature.

The rod 24 has a rod hole 241. The rod hole 241 is attached to a control member 4 at a control member mounting hole 242 with a washer 15 and connector 13. The cylinder with protruding trunnions 22 mates with a mating hole 281 on a positioning system bracket 28, connected to a positioning system arm 25; and a mating hole 282 on the support arm 27. The control member 4 is connected to the support arm 27 with a connector 11 and washers 10, 12. The double spring linear adjusting lock is released by rotating its sleeve with blade 21 through an acute angle. This is done with a release actuator 14, that rotates a lever 26. The lever 26, in turn, rotates the sleeve with blade 21 through an acute angle.

FIG. 1B shows the present invention, a single spring linear adjusting lock device, in situ, with a memory armrest. The single spring linear adjusting lock is comprised of a rod 24, a return spring 170, a two-piece housing 30A, 30B, a bearing 180, a single coil spring 190, a notched sleeve with blade 210, a bushing with a ramp feature 230, and a cylinder with protruding trunnions 220. There is a gap 31 between the two pieces 30A, 30B of the two-piece housing 30A, 30B. The rod 24 has a rod hole 241. The rod 24 has a smooth, cylindrical end 243. The return spring 170, two-piece housing 30A, 30B, bearing 180, coil spring 190, notched sleeve with blade 210, bushing with a ramp feature 230, and cylinder with protruding trunnions 220 all fit over the smooth, cylindrical end 243 of the rod 24. The cylinder with protruding trunnions 220 has an open end 223 through which the smooth, cylindrical end 243 of the rod 24 extends.

The rod hole 241 is attached to a control member 4 at a control member mounting hole 242 with a washer 15 and connector 13. The protrusions, or trunnions, 221, 222 of the cylinder with protruding trunnions 220 mate with a mating hole 281 on a positioning system bracket 28 and a mating hole on the support arm 27. This means that the single spring linear adjusting lock can fit in the same applications as the double spring linear adjusting lock. The control member 4 is connected to the support arm 27 with a connector 11 and washers 10, 12. The positioning system bracket 28 is connected to the positioning system arm 25.

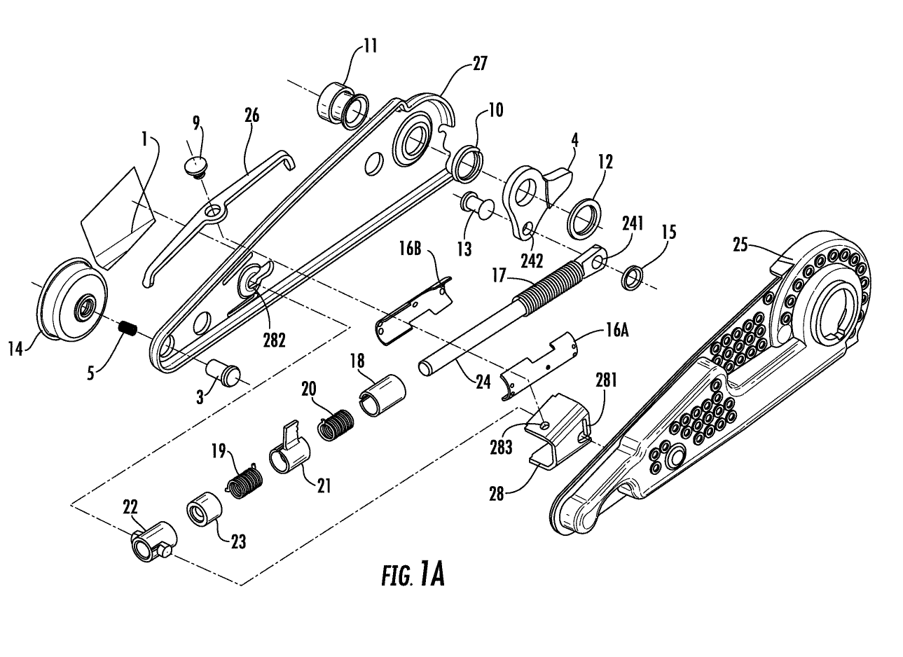

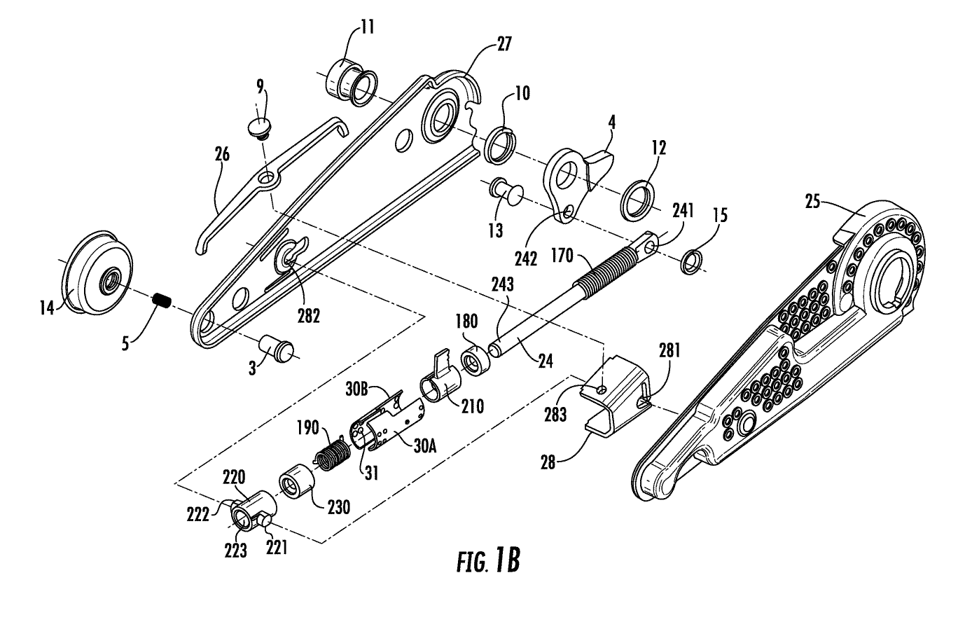

FIGS. 2A and 2B show a comparison of the two-piece housing 16A used with the double spring linear adjusting lock and the two-piece housing 30A used with the single spring linear adjusting lock. The two-piece housing 30A of the single spring linear adjusting lock has a long radial edge 302; a short radial edge 305; two opposing short edges 300, 303; two opposing long edges 304, 310; two short spline edges 307, 308; an outer surface 301; a large hole 309; and a plurality of small holes 311.

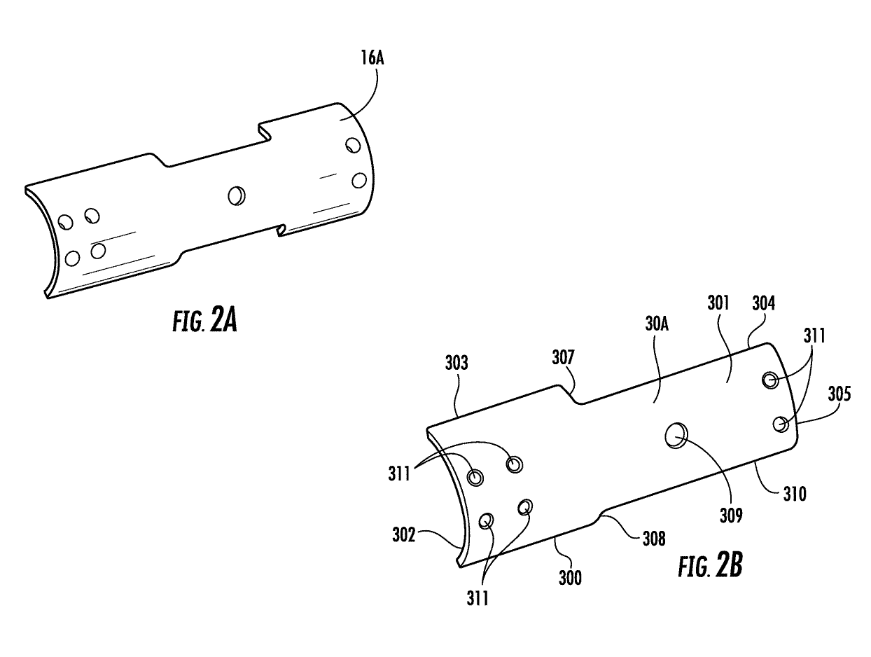

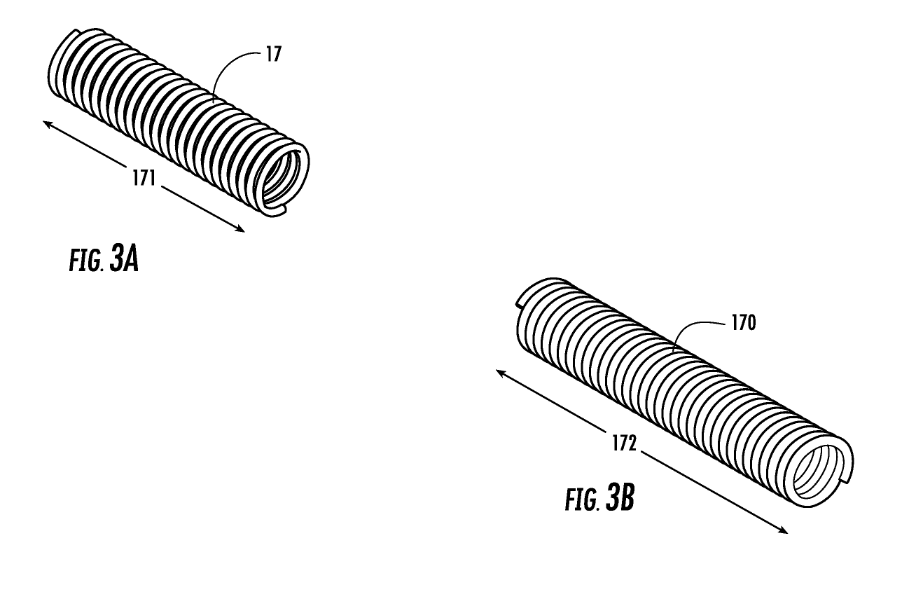

FIGS. 3A and 3B show a comparison of the return spring 17 used with the double spring linear adjusting lock and the return spring 170 used with the single spring linear adjusting lock. The primary difference is that the return spring 170 for the single spring linear adjusting lock is slightly longer 172 than the return spring 17 for the double spring linear adjusting lock 17, 171.

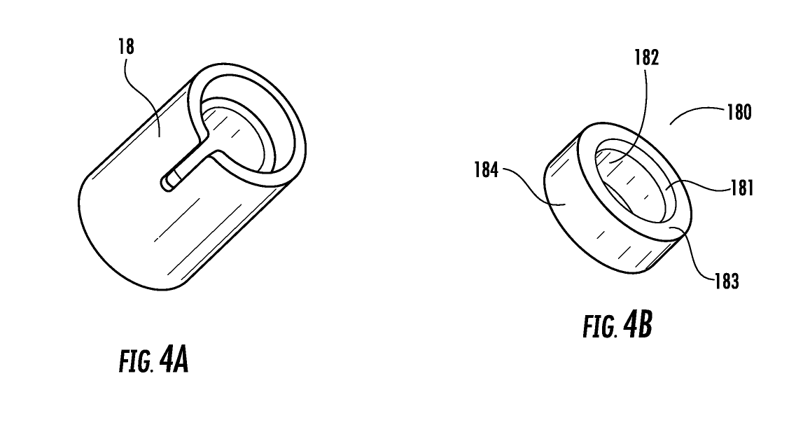

FIG. 4A shows the notched bushing 18 used in the double spring linear adjusting lock. FIG. 4B shows the bearing 180 that is used with the single spring linear adjusting lock. The bearing 180 has an edge surface 183; an inner surface 182; an outer surface 184; and a ramp feature 181. The ramp feature 181 is a transitional bevel from the inner surface 182 to the edge surface 183.

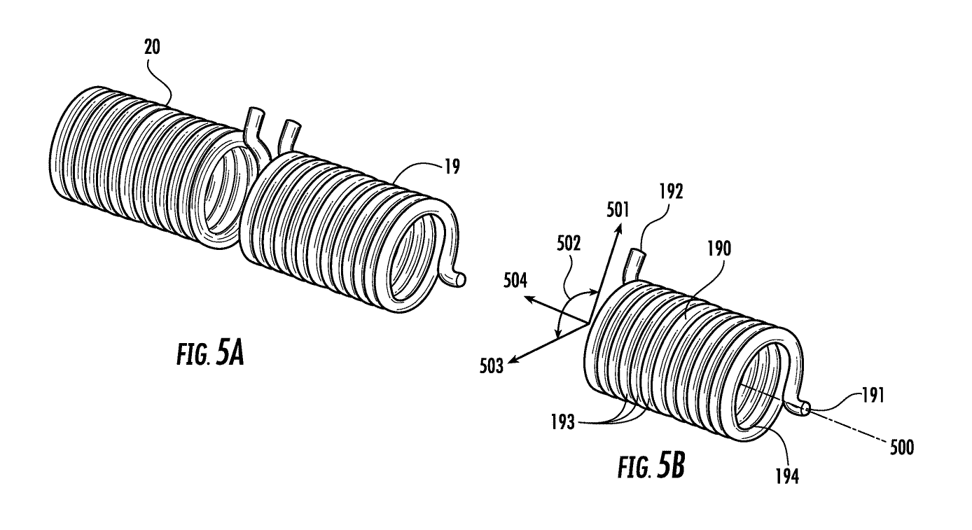

FIG. 5A shows the two coil springs 19, 20 used in the double spring linear adjusting lock. FIG. 5B shows the single coil spring 190 used in the single spring linear adjusting lock. The single coil spring 190 has a plurality of coils or turns 193, and two terminating tangs 191, 192. The terminating tangs 191, 192 can extend either radially 501 or axially 504 away from the single coil spring 190. FIG. 5B shows one tang 192 extends radially 501 away from the single coil spring 190; the other tang 191 extends axially 500 away from the single coil spring 190. The two terminating tangs 191, 192 can be angularly 502 aligned with one another, or they can be angularly 502 offset. FIG. 5B shows the two tangs 191, 192 rotated, angularly 502, approximately 90° from one another.

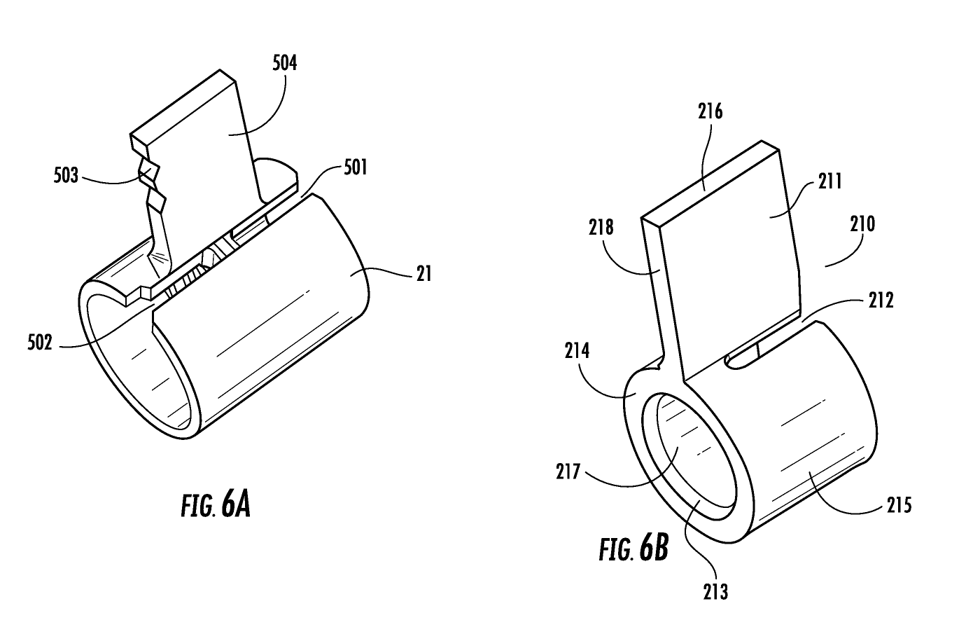

FIG. 6A shows notched sleeve with blade 21 used in the double spring linear adjusting lock. The notched sleeve with blade 21 has two notches 501, 502, and a serrated edge 503 on the blade 504. FIG. 6B shows the notched sleeve with blade 210 used in the single spring linear adjusting lock. The notched sleeve with blade 210 has only one notch 212. The blade 211 has smooth edges 216, 218. The notched sleeve with blade 210 has an outer surface 215; an inner surface 217; a radial surface 214; and a ramp feature 213. The ramp feature 213 is accomplished by creating a beveled surface 213 between the radial surface 214 and the inner cylindrical surface 217.

With reference to the single spring linear adjusting lock, when a compressive load is applied to the armrest 1, the ramp feature inside the bushing 230 causes the coil spring 190 coils 193 to tilt and grip the rod 24 in proportion to the load. When a tensile load is applied to the armrest 1, a ramp feature 213 inside the notched sleeve with blade 210 causes the coil spring 190 coils 193 to tilt in the opposite orientation and grip the rod in proportion to the load. The single spring linear adjusting lock is released by rotating its sleeve with blade 210 through an acute angle. This is done with a release actuator 14 that rotates a lever 26. The lever 26, in turn, rotates the sleeve with blade 210 through an acute angle. The coil spring 190 is unwound, slightly, which causes the inside diameter 194 of each turn 193 of the coil spring 190 to increase until there is a clearance between the coil spring 190 and the rod 24. This condition is called the unlocked condition.

The Axial Lock is comprised of the two-piece housing 30A, 30B, annular bearing 180, single coil spring 190, notched sleeve with blade 210, bushing with a ramp feature 230, and cylinder with protruding trunnions 220. In the unlocked condition, the Axial Lock is free to move axially with respect to the rod 24 to provide a re-positioning function. The Axial Lock is re-locked to the rod 24, in any position, by removing the pressure on the sleeve blade 211. In the locked condition, the Axial Lock is fixed with respect to the rod 24. The single spring linear adjusting lock allows the relative distance between the control member 4 and the positioning system bracket 28 to be adjusted by sliding the Axial Lock along the rod 24. When the blade 211 is released, the armrest 1 will remember the new position, because the relative distance between the control member 4 and the positioning system bracket 28 will be locked. This sets the new use position for the armrest 1.

The release actuator 14 is held in place with a connector 3, 5. The lever 26 is held in place by a connector 9 inserted into a hole 283 in the positioning system bracket 28.

We claim:

1. A single coil spring linear adjusting lock device comprising a rod with one smooth, cylindrical end and disposed opposite the smooth, cylindrical end, an opposing end with a mounting hole;
a return spring;
a two-piece housing wherein each piece of the two-piece housing is a section of a cylindrical surface having two radial edges, wherein both radial edges have an arc of less than 180°;
an annular bearing;
a single coil spring with a plurality of coils, and two terminating tangs;
a notched sleeve with an orthogonal blade, which has a ramp feature, an inner surface, an outer surface, and at least one radial surface, wherein one of the single coil spring tangs is capable of mating with the notch;
a bushing with a ramp feature, wherein the bushing has an inner cylindrical surface, an outer cylindrical surface, and at least one radial surface;
and a cylinder with protruding trunnions and two open ends;
wherein a compressive load applied to the single coil spring linear adjusting lock device causes the ramp feature inside the bushing to cause the coils of the single coil spring to tilt and grip the rod; and
wherein a tensile load applied to the single coil spring linear adjusting lock device causes the ramp feature inside the notched sleeve to cause the coils of the single coil spring to tilt and grip the rod.

2. The single coil spring linear adjusting lock device of claim 1, wherein the coils of the single coil spring tilt and grip the rod with a force proportional to an applied compressive load.

3. The single coil spring linear adjusting lock device of claim 1, wherein the coils of the single coil spring tilt and grip the rod with a force proportional to an applied tensile load

4. The single coil spring linear adjusting lock device of claim 1, wherein the single coil spring linear adjusting lock device is unlocked by rotating the orthogonal blade of the notched sleeve through an acute angle.

5. The single coil spring linear adjusting lock device of claim 4, wherein rotating the orthogonal blade of the notched sleeve through an acute angle unwinds the coils of the single coil spring, making the effective inner radius of the coils of the single coil spring larger.

6. The single coil spring linear adjusting lock device of claim 1, wherein the opposing end of the rod has two flattened surfaces, and the mounting hole passes through both surfaces.

7. The single coil spring linear adjusting lock device of claim 6, wherein the two flattened surfaces are parallel.

8. The single coil spring linear adjusting lock device of claim 1, wherein the ramp feature of the bushing is accomplished by beveling from the inner cylindrical surface of the bushing to the at least one radial surface of the bushing.

9. The single coil spring linear adjusting lock device of claim 1, wherein the ramp feature of the notched sleeve with an orthogonal blade is accomplished by beveling from the inner surface of the notched sleeve with an orthogonal blade to the at least one radial surface of the notched sleeve with an orthogonal blade.

10. The single coil spring linear adjusting lock device of claim 1, wherein the rod is fabricated from at least one of steel, aluminum, zinc, magnesium, poly(methyl-methacrylate) (“PMMA”), polycarbonate (“PC”), acrylonitrile butadiene styrene (“ABS”), polypropylene (“PP”), high-density polyethylene (“HDPE”), and low-density polyethylene (“LDPE”).

11. A memory armrest comprised of
a support arm;
an actuator button;
a lever;
a control member;
a positioning system bracket;
a positioning system arm; and
a single spring linear adjusting lock device;
wherein the single spring linear adjusting lock device, when in locked position, allows the memory armrest to be returned to a prior use position.

12. The memory armrest of claim 11, wherein depressing the actuator button rotates the lever, unlocking the single spring linear adjusting lock device, allowing a new use position to be set.

13. The memory armrest of claim 12, wherein the single spring linear adjusting lock device is comprised of
a rod with one smooth, cylindrical end and disposed opposite the smooth, cylindrical end, an opposing end with a mounting hole;
a return spring;
a two-piece housing wherein each piece of the two-piece housing is a section of a cylindrical surface having two radial edges, wherein both radial edges have an arc of less than 180°;
an annular bearing;
a single coil spring with a plurality of coils;
a notched sleeve with an orthogonal blade, and a ramp feature, which has an inner surface, and outer surface, and at least one radial surface;
a bushing with a ramp feature, wherein the bushing has an inner cylindrical surface, an outer cylindrical surface, and at least one radial surface;
and a cylinder with protruding trunnions and two open ends;
wherein a compressive load applied to the single coil spring linear adjusting lock device causes the ramp feature inside the bushing to cause the coils of the single coil spring to tilt and grip the rod; and
wherein a tensile load applied to the single coil spring linear adjusting lock device causes the ramp feature inside the notched sleeve to cause the coils of the single coil spring to tilt and grip the rod.

14. The memory armrest of claim 13, wherein, within the single coil spring linear adjusting lock device, the coils of the single coil spring tilt and grip the rod with a force proportional to an applied compressive load.

15. The memory armrest of claim 13, wherein, within the single coil spring linear adjusting lock device, the coils of the single coil spring tilt and grip the rod with a force proportional to an applied tensile load

16. The memory armrest of claim 13, wherein the single coil spring linear adjusting lock device is unlocked by rotating the orthogonal blade of the notched sleeve through an acute angle.

17. The memory armrest of claim 16, wherein, within the single coil spring linear adjusting lock device, rotating the orthogonal blade of the notched sleeve through an acute angle unwinds the coils of the single coil spring, making the effective inner radius of the coils of the single coil spring larger.

18. The memory armrest of claim 13, wherein, within the single coil spring linear adjusting lock device, the opposing end of the rod has two flattened surfaces, and the mounting hole passes through both surfaces.

19. The memory armrest of claim 18, wherein, within the single coil spring linear adjusting lock device, the two flattened surfaces of the rod are parallel.

20. The memory armrest of claim 13, wherein, within the single coil spring linear adjusting lock device, the ramp feature of the bushing is accomplished by beveling from the inner cylindrical surface of the bushing to the at least one radial surface of the bushing.

21. The memory armrest of claim 13, wherein, within the single coil spring linear adjusting lock device, the ramp feature of the notched sleeve with an orthogonal blade is accomplished by beveling from the inner surface of the notched sleeve with an orthogonal blade to the at least one radial surface of the notched sleeve with an orthogonal blade.

22. The memory armrest of claim 13, wherein, within the single coil spring linear adjusting lock device, the rod is fabricated from at least one of steel, aluminum, zinc, magnesium, poly(methyl-methacrylate) (“PMMA”), polycarbonate (“PC”), acrylonitrile butadiene styrene (“ABS”), polypropylene (“PP”), high-density polyethylene (“HDPE”), and low-density polyethylene (“LDPE”).
